(19) United States
(12) Patent Application Publication
(10) Pub. No.: US 2016/0273972 A1
(43) Pub. Date: Sep. 22, 2016

(54) Appearance-Changing Indicators For Packaging

(71) Applicants: PRINTPACK ILLINOIS, INC., Elgin, IL (US); SUN CHEMICAL CORPORATION, Parsippany, NJ (US)

(72) Inventors: Mike Schmidt, Charlotte, NC (US); Dave Pisak, York, SC (US); Tom DeBartolo, Waxhaw, NC (US); Grant R. Samm, Liberty Township, OH (US)

(73) Assignees: PRINTPACK ILLINOIS, INC., Elgin, IL (US); SUN CHEMICAL CORPORATION, Parsippany, NJ (US)

(21) Appl. No.: 14/778,230

(22) PCT Filed: Mar. 20, 2014
(86) PCT No.: PCT/US14/31305

§ 371 Date: Sep. 18, 2015

Related U.S. Application Data
(60) Provisional application No. 61/803,615, filed on Mar. 20, 2013.

(51) Int. Cl. G01K 11/12

(52) U.S. Cl. CPC G01K 11/12

(57) ABSTRACT

Appearance-changing indicators are provided that include a substrate having two or more portions configured to undergo one or more visible color changes when exposed to one or more transition temperatures to reveal one or more markings. A conventional ink is printed onto the substrate to form a first marking. A first thermochromic ink is printed onto the substrate to form a second marking adjacent to and at least partially surrounding the first marking and is further printed onto the substrate to form a third marking. The first marking is embedded within the second marking to disguise the first marking without substantially overlapping the first marking, such that the first marking becomes visible when a first transition temperature is reached or exceeded. Also disclosed are methods of fabricating such appearance-changing indicators.

### CROSS-REFERENCE TO RELATED APPLICATIONS

The present application claims the benefit of U.S. Provisional Application No. 61/803,615, filed Mar. 20, 2013, which is incorporated herein by reference in its entirety.

### BACKGROUND

The present application relates generally to appearance-changing indicators for packaging. More particularly, the present application relates to appearance-changing indicators that utilize one or more thermochromic inks to indicate when one or more transition temperatures have been reached or exceeded.

Generally speaking, it is known that thermochromic inks change color in response to temperature fluctuations. In their simplest form, thermochromic inks are materials, for example liquid crystal based materials, leuco dyes, or inorganic materials, that exhibit a change in color or transparency to light in response to temperature fluctuations. Thermochromic inks have frequently been used to provide visual features on packaging material for industries such as food, pharmaceutical or personal care, to indicate, for example, whether the product contained therein is safe for consumption or use. However, when the visual feature is one of a message or marking based on either a thermochromic ink or a conventional ink, thermochromic inks have been found to be inefficient in hiding or concealing the message or marking prior to the transition temperature for which the message or marking is to be revealed. This drawback is associated with the lack of opacity of thermochromic inks. While some thermochromic inks are opaque, most are transparent or translucent and therefore lack the ability to effectively hide or conceal a message or marking by simply overlaying the message or marking with that of a thermochromic ink. Further attempts to hide or conceal a message or marking were made by simply trapping (overlaying) two thermochromic inks over the message or marking, however such attempts still did not provide the requisite opacity needed and thus suffered from the same drawbacks, along with additional costs attributed to the increase in number of thermochromic inks used.

Thus, there exists a need to provide appearance-changing indicators which utilize one or more thermochromic inks to indicate when one or more transition temperatures have been reached or exceeded and effectively hide or conceal a message or marking prior to the transition temperature for which the message or marking is to be revealed, while avoiding one or more of the aforementioned drawbacks.

### SUMMARY

Embodiments of the present description address the above-described need by providing appearance-changing indicators and methods for their manufacture.

The present teachings provide for an appearance-changing indicator for a package for containing product therein, in which the indicator includes a substrate having two or more portions configured to undergo one or more visible color changes when exposed to one or more transition temperatures to reveal one or more markings. The appearance-changing indicator further comprises a conventional ink printed onto a first of the two or more portions to form a first of the one or more markings. The appearance-changing indicator further comprises a first thermochromic ink printed onto one or more areas of the first portion to form a second of the one or more markings adjacent to and at least partially surrounding the first marking and further printed onto a second of the two or more portions to form a third of the one or more markings, in which the first thermochromic ink undergoes a first of the one or more visible color changes when a first of the one or more transition temperatures is reached or exceeded. Thus, the first marking is embedded within the second marking to disguise the first marking without substantially overlapping the first marking, such that the first marking becomes visible when the first transition temperature is reached or exceeded.

The present teachings also provide for a method of fabricating an appearance-changing indicator for a package for containing product therein. The method includes printing a conventional ink onto a first of two or more portions of a substrate to form a first of one or more markings, printing a first thermochromic ink onto one or more areas of the first portion to form a second of the one or more markings adjacent to and at least partially surrounding the first marking, so that the first marking is embedded within the second marking to disguise the first marking without substantially overlapping the first marking, and printing the first thermochromic ink onto a second of the two or more portions to form a third of the one or more markings. Thus, when a first of one or more transition temperatures is reached or exceeded, the first thermochromic ink undergoes a first of one or more visible color changes and the first marking becomes visible.

### BRIEF DESCRIPTION OF DRAWINGS

The present teachings are illustratively shown and described in reference to the accompany drawings, in which

FIG. 1A is a top plan view of an appearance-changing indicator at ambient temperature, according to one embodiment;

FIG. 1B is a top plan view of the appearance-changing indicator of FIG. 1A at a first transition temperature;

FIG. 2A is a top plan view of an appearance-changing indicator at ambient temperature, according to another embodiment;

FIG. 2B is a top plan view of the appearance-changing indicator of FIG. 2A at a second transition temperature;

FIG. 2C is a top plan view of the appearance-changing indicator of FIG. 2A at a first transition temperature;

FIG. 3A is a top plan view of an appearance-changing indicator at ambient temperature, according to another embodiment;

FIG. 3B is a top plan view of the appearance-changing indicator of FIG. 3A at a second transition temperature; and

FIG. 3C is a top plan view of the appearance-changing indicator of FIG. 3A at a first transition temperature.

### DETAILED DESCRIPTION

The present teachings are directed to appearance-changing indicators for packages that reveal one or more markings when exposed to fluctuations in temperature. Also provided herein are methods of fabricating the appearance-changing indicators. Parameters of different steps, components, and features of the embodiments are described separately, but may be combined consistently with this description and claims to enable other embodiments as will be understood by those skilled in the art.

Generally described, the appearance-changing indicators of the present teachings include a substrate having two or more portions configured to undergo one or more visible color changes when exposed to one or more transition temperatures to reveal one or more markings, a conventional ink printed onto a first of the two or more portions to form a first one of the one or more markings, a first thermochromic ink printed onto one or more areas of the first portion to form a second of the one or more markings adjacent to and at least partially surrounding the first marking and further printed onto a second of the two or more portions to form a third of the one or more markings. The term transition temperature, as used herein, is the color transition temperature of a thermochromic ink for which the thermochromic ink is configured to undergo a visible color change. As used herein, the term visible is defined as being discernible or recognizable to a human eye, whereas the term invisible is defined as being indiscernible or unrecognizable to a human. A visible color change may include going from a colored state to a colorless state (invisible), from a colorless state (invisible) to a colored state, or from one colored state to another colored state. The visible color changes of the substrate may be reversible, irreversible, or combinations thereof Further, separate portions of the substrate may go through separate and distinct visible color changes over a course of various temperature fluctuations. In certain embodiments a roll of package material comprising the appearance-changing indicator may be used to form a package for containing product therein. In certain embodiments, a roll of flexible film material comprising the appearance-changing indicator may be used to form a label that is affixed to a package for containing product therein.

In certain embodiments, the substrate may be a label. In other embodiments, the substrate may be the package material used to form the package itself In either instance, the substrate may be formed using any film materials suitable for use in packaging the product concerned. The substrate may be formed as a laminate or non-laminate, a co-extruded film, a cast film, an adhesive label, a shrink wrap label, or the like. For example, in certain embodiments, the substrate may be a non-barrier or barrier structure including one or more layers of one or more paper-based materials, polymeric materials, metallized polymeric materials, metallic foils, and combinations thereof Non-limiting examples include single layer or multi-layer films of suitable polymers, including but not limited to polyolefins, such as polypropylene (PP) or polyethylene (PE), or the like, polyesters, such as polyethylene terephthalate (PET) or the like, polyamides (PA), polystyrenes (PS), and coated paper, it being understood that many other polymers, copolymers, or combinations thereof are also suitable. These materials may be produced as a cast or blown film and may be subsequently biaxially or monoaxially oriented. Further functionality may be added by coating the materials by a vacuum deposition, aqueous deposition, spray process or other means. In certain embodiments, the substrate may be flexible, for example, a flexible label or package. In certain embodiments, the substrate may be semi-rigid, for example a semi-rigid label or package. In certain embodiments, the substrate may be rigid, for example, a rigid package or container such as a cup or carton.

In certain embodiments in which the substrate takes the form of a label, the substrate may be adhered to the package by the use of one or more adhesives, e.g. pressure sensitive adhesives, or alternatively any other type of bonding method using heat sealing, cold sealing, ultrasonic sealing, radio frequency welding, induction welding, or combinations thereof. The one or more adhesives may be any known agent or material which provides the desired affinity between the substrate and the package at the preferred locations. Non-limiting examples of suitable adhesives materials include acrylics, rubbers, hot glues, or combinations thereof. Further, the substrate in the form of the label may be applied to the package in off-line or in-line processes with respect to packaging of the product. For example, the substrate may be applied to the package material that forms the package in-line just before the package is formed, filled with product, and sealed. Alternatively, the substrate may be applied to the package material, wound on a reel and then loaded onto the packaging equipment on which it is then unwound and formed, filled with product, and sealed.

The appearance-changing indicator further comprises a conventional ink that is printed onto a first of the two or more portions of the substrate to form a first of the one or more markings. As used herein, the term conventional ink, in contrast to a thermochromic ink, is defined as a standardized ink that does not undergo a visible color change in response to fluctuations in temperature. The appearance-changing indicator further comprises a first thermochromic ink printed onto one or more areas of the first portion to form a second of the one or more markings adjacent to and at least partially surrounding the first marking, in which the first thermochromic ink undergoes a first of the one or more visible color changes when a first of the one or more transition temperatures is reached or exceeded. The first marking is embedded within the second marking to disguise the first marking without substantially overlapping the first marking. The expression “without substantially overlapping” means that there is no more than incidental overlap between the adjacent markings. Embedding the first marking within the second marking allows for the first marking to be disguised or concealed prior to reaching or exceeding the first transition temperature for which the first thermochromic ink undergoes the first visible color change. The first thermochromic ink is also further printed onto a second portion of the two or more portions of the substrate to form a third of the one or more markings that is visible until the first transition temperature is reached or exceeded. Upon the first transition temperature being reached or exceeded, the second and third markings undergo the first visible color change, while the previously concealed first marking formed of the conventional ink is now therefore visible. Once the first transition temperature is no longer maintained or exceeded, the second and third markings will reappear and the first marking will again become embedded and therefore disguised or concealed. In certain embodiments, the color of the first thermochromic ink and the conventional ink may be substantially similar in at least one of shade or density to further embed or encrypt the one or more markings printed onto the substrate. In other embodiments, the sequence of the one or more visible color changes may be reversed, such that the first marking is visible until the first transition temperature is reached or exceeded, and then subsequently becomes disguised or concealed while the second and third markings are visible.

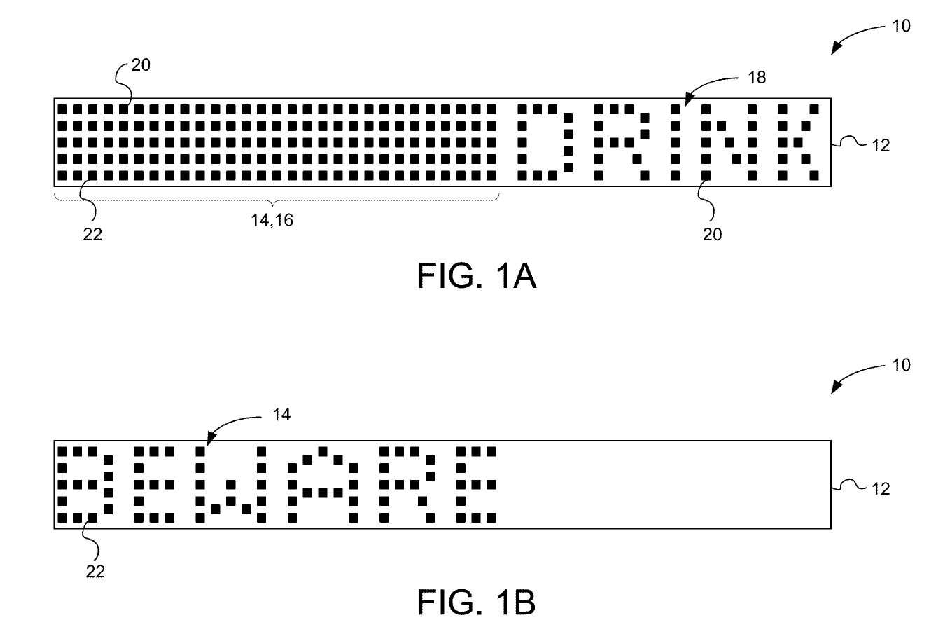

An exemplary embodiment of an appearance-changing indicator 10 viewed under different temperature conditions is illustrated in FIGS. 1A and 1B. The appearance-changing indicator 10 includes a substrate 12 and three markings printed thereon, a first marking 14 in the form of the word BEWARE, a second marking 16, and a third marking 18 in the form of the word DRINK. In FIG. 1A, the appearance-changing indicator 10 is exposed to ambient temperature for which the third marking 18 formed of the first thermochromic ink 20 is visible and the first marking 14 formed of the conventional ink 22 is disguised or concealed. The first marking 14 is disguised as a result of being embedded within the second marking 16 formed of the first thermochromic ink 20 that is adjacent to and at least partially surrounding the first marking 14. In FIG. 1B, the appearance-changing indicator 10 is exposed to a first transition temperature, e.g. 45° C., in which the second and third markings 16 and 18, both formed of the first thermochromic ink 20, undergo a first visible color change, thereby revealing the first marking 14 formed of the conventional ink 22. In other embodiments, the positioning of the one or more markings, as well as the sequence of visible color changes may be reversed.

In certain embodiments, the appearance-changing indicator may further include a second thermochromic ink printed onto one or more areas of the second portion of the substrate to form a fourth of the one or more markings adjacent to and at least partially surrounding the third marking in which the second thermochromic ink undergoes a second of the one or more visible color changes when a second of the one or more transition temperatures is reached or exceeded. The third marking is embedded within the fourth marking to disguise the third marking without substantially overlapping the third marking. Embedding the third marking within the fourth marking allows for the third marking to be disguised or concealed prior to reaching or exceeding the second transition temperatures for which the second thermochromic ink undergoes the second visible color change. Thus, upon the second transition temperature being reached or exceeded, the fourth marking undergoes the second visible color change, while the previously concealed third marking is now therefore visible and revealed. Once the second transition temperature is no longer maintained or exceeded, the fourth marking will reappear and the third marking will again become embedded and therefore disguised or concealed. In certain embodiments, the color of the first and second thermochromic inks and the color of the conventional ink may be substantially similar in at least one of shade or density to further embed or encrypt the one or more markings printed onto the two or more portions of the substrate. In other embodiments, the sequence of the visible color changes of the thermochromic inks may be reversed. It should be noted that depending on the desired application, the first transition temperature, in certain embodiments, may be greater than the second transition temperature, for example to indicate a heating process, whereas in other embodiments, the first transition temperature may be less than the second transition temperature, for example to indicate a cooling process.

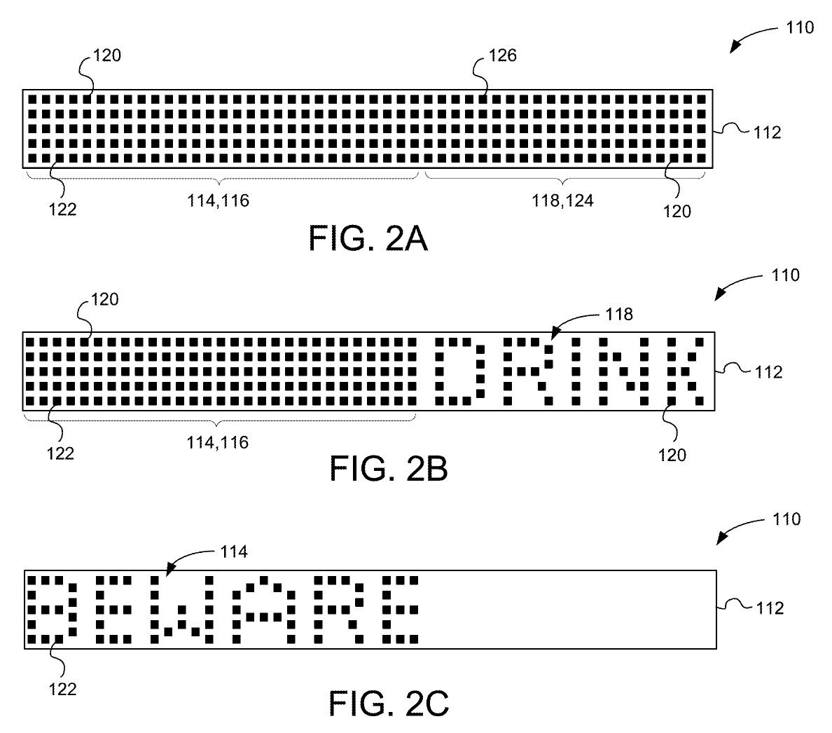

An exemplary embodiment of an appearance-changing indicator 110 viewed under different temperature conditions is illustrated in FIGS. 2A-2C. Similarly to the appearance-changing indicator of FIGS. 1A and 1B, the appearance-changing indicator 110 includes a substrate 112, a first marking 114 in the form of the word BEWARE, a second marking 116, and a third marking 118 in the form of the word DRINK. The appearance-changing indicator 110 further comprises a fourth marking 124 formed of a second thermochromic ink 126 printed onto one or more areas of the substrate 112 that are adjacent to and at least partially surround the third marking 118. In FIG. 2A, the appearance-changing indicator 110 is exposed to ambient temperature for which the first and third markings 114 and 118 are disguised or concealed. The third marking 118 is disguised or concealed as a result of being embedded within the fourth marking 124, whereas the first marking 114 is disguised or concealed as a result of being embedded within the second marking 116. In FIG. 2B, the appearance-changing indicator 110 is exposed to a second transition temperature, e.g. 35° C., in which the fourth marking 124, formed of the second thermochromic ink 126, undergoes the second visible color change, thereby revealing the third marking 118. In FIG. 2C, the appearance-changing indicator 110 is exposed to a first transition temperature, e.g. 45° C., in which the second and third markings 116 and 118, both formed of the first thermochromic ink 120, undergo the first visible color change, thereby revealing the first marking 114 formed of the conventional ink 122.

In certain embodiments, the second thermochromic ink may be further printed onto a third of the two or more portions of the substrate to form a fifth of the one or more markings that is visible until the second transition temperature is reached or exceeded. Thus, upon the second transition temperature being reached or exceeded, the fourth and fifth markings undergo the second visible color change, while the previously concealed third marking is therefore now visible. Once the second transition temperature is no longer maintained or exceeded, the fourth and fifth markings will reappear and the third marking will again become embedded and disguised or concealed.

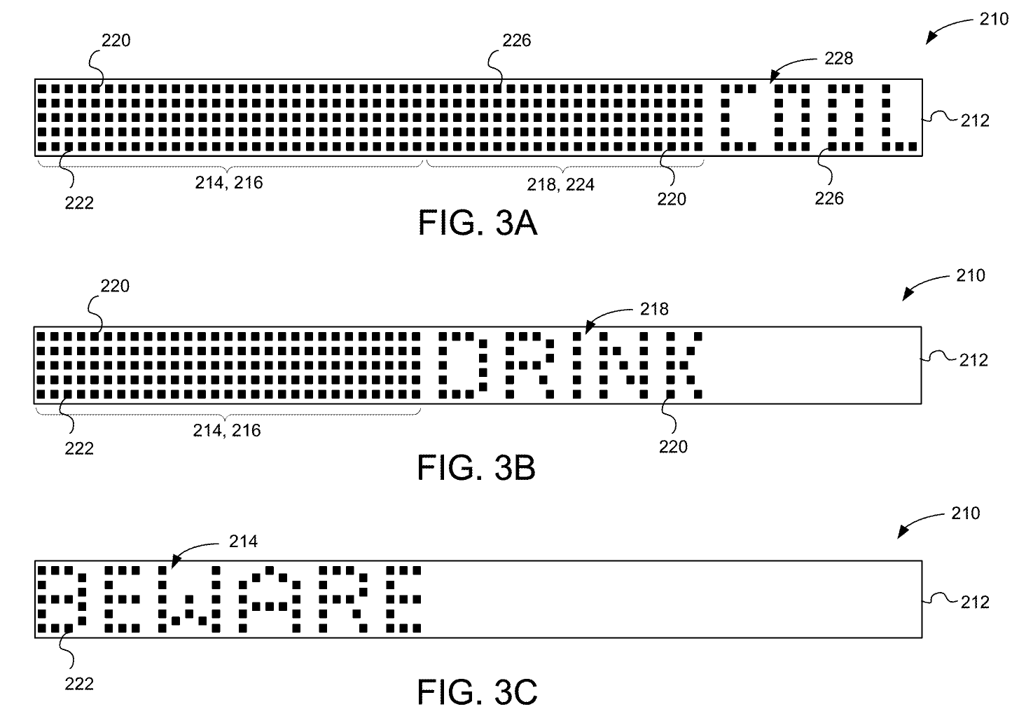

An exemplary embodiment of an appearance-changing indicator 210 viewed under different temperature conditions is illustrated in FIGS. 3A-3C. Similarly to the appearance-changing indicator of FIGS. 2A-2C, the appearance-changing indicator 210 includes a substrate 212, a first marking 214 in the form of the word BEWARE, a second marking 216, a third marking 218 in the form of the word DRINK, and a fourth marking 224. The appearance-changing indicator 210 further comprises a fifth marking 228 in the form of the word COOL and formed of the second thermochromic ink 226. In FIG. 3A, the appearance-changing indicator 210 is exposed to ambient temperature for which the fifth marking 228 is visible. The third marking 218 is disguised or concealed as a result of being embedded within the fourth marking 224, whereas the first marking 214 is disguised or concealed as a result of being embedded within the second marking 216. In FIG. 3B, the appearance-changing indicator 210 is exposed to a second transition temperature, e.g. about 35° C., in which the fourth and fifth markings 224 and 228, both formed of the second thermochromic ink 226, undergo the second visible color change, thereby revealing the third marking 218. Still referring to FIG. 3B, the first marking 214 is disguised or concealed as a result of being embedded within the second marking 216. In FIG. 3C, the appearance-changing indicator 210 is exposed to a first transition temperature, e.g. 45° C., in which the second and third markings 216 and 218, both formed of the first thermochromic ink 220, undergo the first visible color change, thereby revealing the first marking 214 formed of the conventional ink 222.

Any suitable thermochromic ink or combination of thermochromic inks may be used in accordance with the present teachings. Each thermochromic ink that is printed onto the substrate may undergo a visible change in color at a particular transition temperature, or may gradually change color as the temperature increases or decreases through a temperature range. For simplicity, either type of transition is referred to herein as a “visible color change.” The visible color change of a thermochromic ink may be reversible or irreversible and may include going from a colored state to a colorless state (invisible), from a colorless state (invisible) to a colored state, or from one colored state to another colored state. Numerous thermochromic inks are commercially available. Non- limiting examples include thermochromic inks that undergo a visible color change at about transition temperatures such as, for example −10° C., 4° C., 8° C., 10° C., 12° C., 15° C., 19° C., 23° C., 25° C., 27° C., 29° C., 31° C., 33° C., 35° C., 37° C., 40° C., 43° C., 45° C., 47° C., 55° C., 65° C., 69° C., it being understood that other transition temperatures are also suitable.

The one or more thermochromic inks may be selected to have any color, as desired. Thus, for example, the color may be white, red, orange, yellow, green, blue, pink, purple, tan, brown, black, or any other color. In certain embodiments, upon heating above a transition temperature, one of the one or more thermochromic inks undergoes a visible color change, and upon cooling below the transition temperature, reverts back to its original color. Further, in certain embodiments, upon heating above a second transition temperature, another one of the one or more thermochromic inks undergoes a visible color change, and upon cooling below the second transition temperature, reverts back it is original color. In certain embodiments, upon cooling below a transition temperature, one of the one or more thermochromic inks undergoes a visible color change, and reverts back to its original color upon heating above the transition temperature. Further, in certain embodiments, upon cooling below a second transition temperature, another one of the one or more thermochromic inks undergoes a visible color change, and reverts back to its original color upon heating above the second transition temperature. In certain embodiments, two or more thermochromic inks, each having different transition temperatures, may form a marking, such that the marking may undergo two or more visible color changes at two or more transition temperatures.

Similarly, any suitable conventional ink or combination of conventional inks, may be used in accordance with the present teachings and may be selected to have any color, as desired. Non-limiting examples of conventional inks include standard web based inks, e.g. Chromacor LV®, water based inks, solvent based inks, paste inks, energy curable inks, or combinations thereof. In certain embodiments, in addition to conventional and thermochromic inks, the substrate may also include electrochromic inks, photochromic inks, piezochromic inks, magnetochromic inks, or combinations thereof, printed onto one or more portions thereof to further tailor or customize the indicator itself, or the markings thereon, for the desired application.

The inks selected, the manner in which they are applied to the substrate, and the pattern in which they are applied depend on various factors. Non-limiting factors include the product to be contained in the package, the type of substrate used, and/or the desired transition temperature(s). Thus, it will be understood that the various conventional and thermochromic inks may be applied in the form of any suitable markings, for example, one or more words, numbers, letters, shapes, symbols, continuous or discontinuous design or pattern, or any combination thereof, for a desired application. In certain embodiments, the one or more markings may provide one or more messages such as status information or instructions to the user, and/or that resemble or connote an active, traditional heating or cooling process.

The method of fabricating the appearance-changing indicator for a package provided herein may include printing a conventional ink onto a first of two or more portions of a substrate to form a first of one or more markings, printing a first thermochromic ink onto one or more areas of the first portion to form a second of the one or more markings adjacent to and at least partially surrounding the first marking, and printing the first thermochromic ink onto a second of the two or more portions to form a third of the one or more markings. The first marking is embedded within the second marking to disguise the first marking without substantially overlapping the first mark. Thus, when a first of one or more transition temperatures is reached, the first thermochromic ink undergoes a first of one or more visible color changes and the first marking becomes visible.

In certain embodiments, the method of fabricating the appearance-changing indicator for a package may further include printing a second thermochromic ink onto one or more areas of the second portion of the substrate to form a fourth of the one or more marks adjacent to and at least partially surrounding the third marking, in which the second thermochromic ink undergoes a second of the one or more visible color changes when a second of the one or more transition temperatures is reached or exceeded. The third marking is embedded within the fourth marking to disguise the third marking without substantially overlapping the third marking, such that the third marking becomes visible when the second transition temperature is reached or exceeded. In certain embodiments, the method may further include printing the second thermochromic ink onto a third of the two or more portions to form a fifth of the one or more markings and therefore, also undergoes the second visible color change upon the second transition temperature being reached or exceeded.

The steps of printing the conventional ink and one or more thermochromic inks onto the substrate may include disposing such inks using any suitable printing methods known to those skilled in the art. Non-limiting examples include flexographic printing, rotogravure printing, screen printing, injet printing, or combinations thereof For example, in certain embodiments in which rotogravure printing is used, a screen value of about 35% to 45% may be used to allow for the conventional ink to have substantially the same print strength as that of the one or more thermochromic inks printed onto the substrate at its maximum opacity. In certain embodiments, the printing of the inks onto the substrate may be printed as a patterned or dot matrix with spacing between areas of printed ink so that the one or more markings are legible when revealed at the desired temperature. Further, in certain embodiments, the spacing between areas of printed ink may be substantially similar.

Those skilled in the art will appreciate that the inks maybe combined with additional materials such as, for example binders, defoamers, waxes, or surfactants, to help facilitate the printing of the inks onto the substrate. Further, depending on the desired characteristics of the indicator, additional additives may be incorporated to enhance various properties of the coating formulations. Non-limiting examples include adhesion promoters, light stabilizers, de-gassing additives, flow promoters, antioxidants, UV stabilizers, dispersants, plasticizers, rheological additives, silicones, and inert fillers such as, clay, calcium carbonates, and TiO₂, or combinations thereof.

In certain embodiments, the steps of printing onto the substrate may be performed in off-line or in-line processes with respect to packaging of the product. For example, where the substrate is the package material that forms the package itself, the inks may be applied to the package material that forms the package in-line just before the package is formed, filled with product and sealed. Alternatively, the inks may be applied to the package material that is then wound on a reel and later loaded onto the packaging equipment on which it is then unwound and formed, filled with product and sealed. Further, in certain embodiments, the substrate in the form of a label may be applied to the package in off-line or in-line processes with respect to packaging of the product.

In certain embodiments, the method of fabricating the appearance-changing indicator for a package provided herein may further include applying one or more adhesives onto the substrate to adhere the substrate to the package. The one or more adhesives may be applied onto the substrate using any suitable methods known to those skilled in the art. The one or more adhesives can be applied by anilox rollers, engraved cylinder or other means to the substrate in the desired pattern, the amount and type of adhesive agent can be varied to obtain the desired result, and then the substrate can subsequently be attached to the package. Alternatively, the one or more adhesives can be applied to package in the same manner as described above, and the substrate can then be applied over the one or more adhesives to attach the substrate to the package.

It will be appreciated that various above-disclosed and other features and functions, or alternatives thereof, may be desirably combined into many other different products or applications. Various presently unforeseen or unanticipated alternatives, modifications, variations, or improvements therein may be subsequently made by those skilled in the art which are also intended to be encompassed by the following claims.

We claim:

1. An appearance-changing indicator for a package for containing product therein, said indicator comprising:
a substrate having two or more portions configured to undergo one or more visible color changes when exposed to one or more transition temperatures to reveal one or more markings;
a conventional ink printed onto a first of the two or more portions to form a first of the one or more markings; and
a first thermochromic ink printed onto one or more areas of the first portion to form a second of the one or more markings adjacent to and at least partially surrounding the first marking and further printed onto a second of the two or more portions to form a third of the one or more markings, the first thermochromic ink undergoing a first of the one or more visible color changes when a first of the one or more transition temperatures is reached or exceeded,
wherein the first marking is embedded within the second marking to disguise the first marking without substantially overlapping the first marking, such that the first marking becomes visible when the first transition temperature is reached or exceeded.

2. The appearance-changing indicator of claim 1, further comprising:
a second thermochromic ink printed onto one or more areas of the second portion to form a fourth of the one or more markings adjacent to and at least partially surrounding the third marking, the second thermochromic ink undergoing a second of the one or more visible color changes when a second of the one or more transition temperatures is reached or exceeded, wherein the third marking is embedded within the fourth marking to disguise the third marking without substantially overlapping the third marking, such that the third marking becomes visible when the second transition temperature is reached or exceeded.

3. The appearance-changing indicator of claim 2, further comprising:
the second thermochromic ink printed onto a third of the two or more portions to form a fifth of the one or more markings.

4. The appearance-changing indicator of claim 1, further comprising electrochromic inks, photochromic inks, piezochromic inks, magnetochromic inks, or any combination thereof.

5. The appearance-changing indicator of claim 2, wherein the second transition temperature is lower than the first transition temperature.

6. The appearance-changing indicator of claim 2, wherein the second transition temperature is greater than the first transition temperature.

7. The appearance-changing indicator of claim 1, wherein the first marking is of a first color, the second marking is of a second color, and the third marking is of a third color, the first, second and third colors being substantially similar in at least one of shade or density.

8. The appearance-changing indicator of claim 2, wherein the first marking is of a first color, the second marking is of a second color, the third marking is of a third color, and the fourth marking is of a fourth color, the first, second, third, and fourth colors being substantially similar in at least one of shade or density.

9. The appearance-changing indicator of claim 3, wherein the first marking is of a first color, the second marking is of a second color, the third marking is of a third color, the fourth marking is of a fourth color, and the fifth marking is of a fifth color, the first, second, third, fourth, and fifth colors being substantially similar in at least one of shade or density.

10. The appearance-changing indicator of claim 1, wherein the substrate is a label.

11. The appearance-changing indicator of claim 10, further comprising one or more adhesives disposed onto the substrate to adhere the substrate to the package.

12. The appearance-changing indicator of claim 1, wherein the substrate is a package material that is subsequently formed into the package.

13. A roll of package material for forming a package for containing product therein, said roll of packaging material comprising the appearance-changing indicator of claim 1.

14. A roll of flexible film material for forming a label that is affixed to a package for containing product therein, said roll of film material comprising the appearance-changing indicator of claim 1.

15. A method of fabricating an appearance-changing indicator for a package for containing product therein, said method comprising:
printing a conventional ink onto a first of two or more portions of a substrate to form a first of one or more markings;
printing a first thermochromic ink onto one or more areas of the first portion to form a second of the one or more markings adjacent to and at least partially surrounding the first marking, so that the first marking is embedded within the second marking to disguise the first marking without substantially overlapping the first marking;
printing the first thermochromic ink onto a second of the two or more portions to form a third of the one or more markings, wherein the first thermochromic ink undergoes a first of one or more visible color changes and the first marking becomes visible when a first of one or more transition temperatures is reached or exceeded.

16. The method of claim 15, further comprising:
printing a second thermochromic ink onto one or more areas of the second portion to form a fourth of the one or more markings adjacent to and at least partially surrounding the third marking, the second thermochromic ink undergoing a second of the one or more visible color changes when a second of the one or more transition temperatures is reached or exceeded, wherein the third marking is embedded within the fourth marking to disguise the third marking without substantially overlapping the third marking, such that the third marking becomes visible when the second transition temperature is reached or exceeded.

17. The method of claim 16, further comprising:
printing the second thermochromic ink onto a third of the two or more portions to form a fifth of the one or more markings.

18. The method of claim 16, wherein the second transition temperature is lower than the first transition temperature.

19. The method of claim 16, wherein the second transition temperature is greater than the first transition temperature.

20. The method of claim 15, further comprising applying one or more adhesives onto the substrate to adhere the substrate to the package.
